(19) United States
(12) Patent Application Publication
(10) Pub. No.: US 2021/0141393 A1
(43) Pub. Date: May 13, 2021

(54) CONTROLLER

(71) Applicant: TOYOTA JIDOSHA KABUSHIKI KAISHA, Aichi-ken (JP)

(72) Inventor: Hayato NAKADA, Minamitsuru-gun (JP)

(21) Appl. No.: 17/093,637

(22) Filed: Nov. 10, 2020

(30) Foreign Application Priority Data
Nov. 11, 2019 (JP) 2019-204247

(51) Int. Cl. G05D 1/02; H04W 4/40; B60L 53/12

(52) U.S. Cl. CPC G05D 1/0295; B60L 53/12; G05D 1/0293; H04W 4/40

(57) ABSTRACT

A controller includes a processor including hardware, the processor being configure to control a leading vehicle in a platoon formed by a plurality of vehicles to supply profitable information or energy that profits a manager who manages the leading vehicle or a person who requests travel of the leading vehicle to a following vehicle in the platoon, the plurality of vehicles communicating with each other to form the platoon.

The present application claims priority to and incorporates by reference the entire contents of Japanese Patent Application No. 2019-204247 filed in Japan on Nov. 11, 2019.

### BACKGROUND

The present disclosure relates to a controller.

A platoon travel system is known (see JP 2014-211715 A, for example). The platoon travel system allows following vehicles to communicate with a leading vehicle. The following vehicles receive travel information about the leading vehicle. Based on the travel information, the leading vehicle and the following vehicles travel in a platoon while maintaining a predetermined distance between the vehicles. In the platoon travel, existence of the leading vehicle reduces drag on the following vehicles. Therefore, mileages or driving ranges of the following vehicles are improved during the travel.

### SUMMARY

In the above platoon travel system, however, the leading vehicle that travels ahead in the platoon has no merit.

There is a need for a controller that allows a vehicle that travels ahead in a platoon to generate merit.

According to one aspect of the present disclosure, there is provided a controller including a processor including hardware, the processor being configure to control a leading vehicle in a platoon formed by a plurality of vehicles to supply profitable information or energy that profits a manager who manages the leading vehicle or a person who requests travel of the leading vehicle to a following vehicle in the platoon, the plurality of vehicles communicating with each other to form the platoon.

### BRIEF DESCRIPTION OF THE DRAWINGS

FIG. 1 is a conceptual drawing of a platoon formed by a plurality of vehicles in a first embodiment;

FIG. 2 is a block diagram illustrating a configuration of a leading vehicle in the first embodiment;

FIG. 3 is a block diagram illustrating a configuration of a following vehicle in the first embodiment;

FIG. 4 is a flowchart of control performed by a controller according to the first embodiment;

FIG. 5 is a flowchart of control performed by a controller of the following vehicle in the first embodiment;

FIG. 6 is a flowchart of details of control performed by a controller according to a modification of the first embodiment;

FIG. 7 is a flowchart of details of control performed by a controller of a following vehicle in the modification of the first embodiment;

FIG. 8 is a conceptual drawing illustrating an outline of a system in a second embodiment;

FIG. 9 is a block diagram illustrating a configuration of a controller (server) according to the second embodiment;

FIG. 10 is a flowchart of details of control performed by a controller of a leading vehicle in the second embodiment;

FIG. 11 is a flowchart of details of control performed by a controller according to the second embodiment;

FIG. 12 is a conceptual drawing illustrating an outline of a system in a third embodiment;

FIG. 13 is a block diagram illustrating a configuration of a leading vehicle in the third embodiment;

FIG. 14 is a block diagram illustrating a configuration of a following vehicle in the third embodiment;

FIG. 15 is a flowchart of details of control performed by a controller according to the third embodiment; and

FIG. 16 is a flowchart of details of control performed by a controller of a following vehicle in the third embodiment.

### DETAILED DESCRIPTION

Hereinafter, modes for carrying out the present disclosure (hereinafter referred to as “embodiments”) will be described with reference to the accompanying drawings.

FIG. 1 is a conceptual drawing of a platoon formed by a plurality of vehicles in a first embodiment. A platoon 100 illustrated in FIG. 1 includes a leading vehicle 1 that travels ahead, and one or a plurality of following vehicles 2 traveling behind the leading vehicle 1. Each of the following vehicles 2 travels while using adaptive cruise control (ACC). The ACC allows each of the following vehicles 2 to maintain a predetermined distance between the following vehicle 2 and a vehicle that travels in front of the following vehicle 2 not to collide with the vehicle. In platoons in embodiments described below, a following vehicles travel while using the ACC. Note that in FIG. 1, the number of the following vehicles 2 is two, as an example.

FIG. 2 is a block diagram illustrating a configuration of the leading vehicle. The leading vehicle 1 includes a steering device 10, a driving device 11, a brake device 12, sensors 13, an electronic control unit (ECU) 14, and a controller 15 that is a controller according to the first embodiment. The steering device 10 includes, for example, a steering device that uses an electric actuator and the like to steer a steering angle of steering of the vehicle. The driving device 11 includes, for example, an internal-combustion engine or a motor-generator that drives the vehicle, and a transmission. The brake device 12 includes, for example, a hydraulic brake device. The hydraulic brake device uses a hydraulic pressure to press a brake pad against a brake rotor. The hydraulic pressure is generated by a brake actuator.

The sensors 13 include, for example, a vehicle speed sensor, a steering-angle sensor, a hydraulic sensor of the hydraulic brake device, a global positioning system (GPS) sensor, or the like. The global positioning system sensor receives radio waves from GPS satellites, and determines position information. The sensors 13 are connected with the ECU 14 through electric cables. The sensors 13 obtain the position information from GPS satellites. The sensors 13 obtain steering information about the vehicle from the steering device 10, obtain driving information about the vehicle from the driving device 11, and obtain brake information about the vehicle from the brake device 12. Hereinafter, the steering information, the driving information, and the brake information will be collectively referred to as travel information. The sensors 13 transmit the obtained position information and the obtained travel information to the ECU 14.

The ECU 14 is connected with the steering device 10, the driving device 11, the brake device 12, the sensors 13, and a control unit 151 through electric cables. The ECU 14 controls steering of the steering device 10, driving of the driving device 11, and braking of the brake device 12. The ECU 14 obtains the travel information and the position information about the leading vehicle 1 from the sensors 13, and transmits the travel information and the position information to the control unit 151.

The controller 15 includes a storage unit 150, the control unit 151, and a communication unit 152. The storage unit 150 includes volatile memory, such as random access memory (RAM), and nonvolatile memory, such as read only memory (ROM).

The storage unit 150 stores information about a service (hereinafter may be referred to as the service information) for which a manager who manages the leading vehicle 1 (the manager includes an owner of the leading vehicle 1) or a person who requests the manager who manages the leading vehicle 1 to travel ahead in the platoon 100 (hereinafter may be referred to as the person who requests the travel) receives consideration. The service information is, for example, information that promotes sales of a product. More specifically, the service information is information, such as a discount coupon for the product or an advertisement for the product. The storage unit 150 also temporarily stores information received or transmitted through the communication unit 152. Note that the above manager and the above person who requests the travel may be an individual or an organization, such as a business. The storage unit 150 stores programs for executing various processes of the controller 15.

The control unit 151 is connected with the communication unit 152, the storage unit 150, and the ECU 14 through electric cables. The control unit 151 transmits, through the communication unit 152, the travel information about the leading vehicle 1, entry position information based on the position information, and the service information in the storage unit 150. The control unit 151 includes a central processing unit (CPU).

The communication unit 152 has a function of performing communication between the leading vehicle 1 and the following vehicles 2. The communication unit 152 may communicate with the following vehicles 2 through Wi-Fi (registered trademark) communication or the like through a communication network. The communication network includes at least one of a local area network (LAN), a wide area network (WAN), the Internet, and the like.

FIG. 3 is a block diagram illustrating a configuration of the following vehicle. Configurations of a steering device 20, a driving device 21, a brake device 22, and sensors 23 are similar to the configurations of the steering device 10, the driving device 11, the brake device 12, and the sensors 13 in FIG. 2, respectively, and thus will not be described.

A radar 26 is a device that detects a distance between the following vehicle and a vehicle that travels in front of the following vehicle. The radar 26 is, for example, a millimeter-wave radar.

An input and output unit 25 includes a touch screen on which a driver inputs information, and a display that outputs and displays information. The input and output unit 25 is, for example, a navigation device used for navigation and display of maps. The input and output unit 25 transmits, to an ECU 24, platoon entry intention information that has been input by a driver. The input and output unit 25 displays service information obtained from the ECU 24 on the display. The input and output unit 25 may include a microphone with which voices are input, and a speaker with which voices are output. Note that the input and output unit 25 may be a device, such as a mobile terminal, that outputs information on a display and performs communication.

The ECU 24 is connected with the steering device 20, the driving device 21, the brake device 22, the sensors 23, the radar 26, a control unit 271, and the input and output unit 25 through electric cables. The ECU 24 obtains, from the control unit 271, travel information and position information about the leading vehicle 1. On the other hand, the ECU 24 obtains, from the sensors 23, travel information and position information about the following vehicle. The ECU 24 controls the steering device 20, the driving device 21, and the brake device 22 based on the obtained travel information and the obtained position information about the leading vehicle 1, the travel information and the position information about the following vehicle, and information about a distance between the following vehicle and a vehicle in front of the following vehicle that has been obtained from the radar 26. The ECU 24 transmits, to the control unit 271, platoon entry intention information obtained from the input and output unit 25, and vehicle information that identifies the following vehicle. The ECU 24 obtains service information from the control unit 271, and outputs the service information with the input and output unit 25.

A controller 27 includes a storage unit 270, the control unit 271, and a communication unit 272. The control unit 271 is connected with the storage unit 270, the ECU 24, and the communication unit 272 through electric cables. The control unit 271 obtains travel information about the leading vehicle 1 or service information from the leading vehicle 1 through the communication unit 272. The control unit 271 transmits the travel information about the leading vehicle 1 or the service information to the ECU 24. The control unit 271 transmits, to the leading vehicle 1 through the communication unit 272, platoon entry intention information and vehicle information that have been obtained from the ECU 24.

FIG. 4 is a flowchart of control performed by the controller of the leading vehicle in the first embodiment. First, in Step S1, the control unit 151 determines whether or not a platoon entry request and vehicle information have been received from a following vehicle 2 through the communication unit 152. If the control unit 151 determines that “a platoon entry request and vehicle information have not been received” (Step S1: No), the controller 15 ends the flowchart of control. If the control unit 151 determines that “a platoon entry request and vehicle information have been received” (Step S1: Yes), the control unit 151 obtains, from the sensors 13 through the ECU 14, travel information and position information about the leading vehicle (Step S2). Then Step S3 is performed.

In Step S3, the control unit 151 transmits platoon entry position information based on the position information obtained from the ECU 14, and the travel information about the leading vehicle to the following vehicle 2 that corresponds to the obtained vehicle information through the communication unit 152. Then Step S4 is performed.

In Step S4, the control unit 151 determines whether or not platoon entry completion information has been received from the following vehicle 2 through the communication unit 152. If the control unit 151 determines that “platoon entry completion information has not been received” (Step S4: No), the control unit 151 performs Step S3 again. If the control unit 151 determines that “platoon entry completion information has been received” (Step S4: Yes), Step S5 is performed.

In Step S5, the control unit 151 transmits, to the following vehicle 2 through the communication unit 152, service information in the storage unit 150. Then Step S6 is performed.

In Step S6, the control unit 151 determines whether or not information that indicates that the service information has not been received has been received from the following vehicle 2 through the communication unit 152 within a predetermined period of time. If the control unit 151 determines that “information that indicates that the service information has not been received has been received” (Step S6: Yes), the control unit 151 performs Step S5 again. If the control unit 151 determines that “information that indicates that the service information has not been received has not been received” (Step S6: No), the controller 15 ends the flowchart of control.

FIG. 5 is a flowchart of control performed by the controller of the following vehicle in the first embodiment. First, in Step S21, the control unit 271 determines, through the ECU 24, whether or not platoon entry intention information has been input into the input and output unit 25. If the control unit 271 determines that “platoon entry intention information has not been input into the input and output unit 25” (Step S21: No), the controller 27 ends the flowchart of control. If the control unit 271 determines that “platoon entry intention information has been input into the input and output unit 25” (Step S21: Yes), the control unit 271 transmits a platoon entry request and vehicle information to the leading vehicle 1 through the communication unit 272 (Step S22). Then Step S23 is performed.

In Step S23, the control unit 271 determines whether or not travel information about the leading vehicle 1 and platoon entry position information have been received from the leading vehicle 1 through the communication unit 272. If the control unit 271 determines that “travel information and platoon entry position information have not been received” (Step S23: No), the control unit 271 performs Step S22 again. If the control unit 271 determines that “travel information and platoon entry position information have been received” (Step S23: Yes), the control unit 271 performs Step S24.

In Step S24, the control unit 271 determines whether or not the following vehicle has completed the entry into the platoon, based on the platoon entry position information obtained from the leading vehicle 1, and position information about the following vehicle obtained from the sensors 23. If the control unit 271 determines that “the following vehicle has not completed the entry into the platoon” (Step S24: No), the control unit 271 repeats Step S24. If the control unit 271 determines that “the following vehicle has completed the entry into the platoon” (Step S24: Yes), the control unit 271 performs Step S25.

In Step S25, based on the obtained travel information about the leading vehicle 1 and the obtained platoon entry position information, the travel information about the following vehicle and the position information about the following vehicle that have been obtained from the sensors 23, and information about a distance between the following vehicle and a vehicle in front of the following vehicle that has been obtained from the radar 26, the ECU 24 controls platoon travel so that a distance between the vehicles is kept within a predetermined distance, and the vehicles do not collide. Then Step S26 is performed.

In Step S26, the control unit 271 transmits platoon entry completion information to the leading vehicle 1. Then Step S27 is performed.

In Step S27, the control unit 271 determines whether or not service information has been received from the leading vehicle 1 through the communication unit 272 within a predetermined period of time. If the control unit 271 determines that “service information has not been received within the predetermined period of time” (Step S27: No), the control unit 271 transmits, to the leading vehicle 1 through the communication unit 272, information that indicates that service information has not been received (Step S28), and the control unit 271 performs Step S27 again. If the control unit 271 determines that “service information has been received within the predetermined period of time” (Step S27: Yes), the control unit 271 performs Step S29.

In Step S29, the control unit 271 makes the input and output unit 25 display the obtained service information through the ECU 24. Then the controller 27 ends the flowchart of control.

As described above, the manager who manages the leading vehicle 1 or the person who requests the travel receives consideration from sales promotion effect by transmitting the service information from the leading vehicle 1 to the following vehicle(s) 2. Therefore, the first embodiment allows traveling ahead in platoon travel to generate merit.

FIG. 6 is a flowchart of details of control performed by a controller according to a modification of the first embodiment. Steps S31 to S33 are similar to Steps S1 to S3 in FIG. 4, and thus will not be described.

In Step S34, a control unit 151 determines whether or not platoon entry completion information and information about a distance between a following vehicle 2 and a vehicle in front of the following vehicle 2 have been received from the following vehicle 2 through a communication unit 152. If the control unit 151 determines that “platoon entry completion information and information about a distance between the vehicles have not been received” (Step S34: No), the control unit 151 performs Step S33 again. If the control unit 151 determines that “platoon entry completion information and information about a distance between the vehicles have been received” (Step S34: Yes), the control unit 151 performs Step S35.

In Step S35, as the distance between the vehicles becomes shorter, the control unit 151 varies (increases) an amount of service information that will be transmitted (for example, increases the number of coupons). Alternatively, as the distance between the vehicles becomes shorter, the control unit 151 varies (increases) quality of service information (for example, increases a discount of a coupon). Then Step S36 is performed. Note that both the amount and the quality of the service information may be varied according to the distance between the vehicles.

In Step S36, the control unit 151 transmits the varied service information to the following vehicle 2 through the communication unit 152. Then Step S37 is performed.

In Step S37, the control unit 151 determines whether or not information that indicates that the service information has not been received has been received from the following vehicle 2 through the communication unit 152 within a predetermined period of time. If the control unit 151 determines that “information that indicates that the service information has not been received has been received within the predetermined period of time” (Step S37: Yes), the control unit 151 performs Step S36 again. If the control unit 151 determines that “information that indicates that the service information has not been received has not been received within the predetermined period of time” (Step S37: No), a controller 15 ends the flowchart of control.

FIG. 7 is a flowchart of details of control performed by a controller of the following vehicle in the modification of the first embodiment. Steps S41 to S45 are similar to Steps S21 to S25 in FIG. 5, and thus will not be described.

In Step S46, a control unit 271 transmits, to a leading vehicle 1 through a communication unit 272, platoon entry completion information, and information about a distance between the following vehicle and a vehicle in front of the following vehicle. Then Step S47 is performed. The information about a distance between the following vehicle and a vehicle in front of the following vehicle has been obtained from a radar 26 through an ECU 24.

In Step S47, the control unit 271 determines whether or not service information has been received from the leading vehicle 1 through the communication unit 272 within a predetermined period of time. If the control unit 271 determines that “service information has not been received within the predetermined period of time” (Step S47: No), the control unit 271 transmits, to the leading vehicle 1 through the communication unit 272, information that indicates that the service information has not been received (Step S48), and the control unit 271 performs Step S47 again. If the control unit 271 determines that “service information has been received within the predetermined period of time” (Step S47: Yes), the control unit 271 performs Step S49.

In Step S49, the control unit 271 makes an input and output unit 25 display the obtained service information through the ECU 24. Then a controller 27 ends the flowchart of control.

As described above, as a distance between the following vehicle 2 and a vehicle in front of the following vehicle 2 becomes shorter, at least one of an amount and quality of service information that will be transmitted is varied. Therefore, the following vehicle 2 shortens the distance between the following vehicle 2 and a vehicle in front of the following vehicle 2. The modification of the first embodiment allows a plurality of vehicles to form a platoon. Consequently, the service information is supplied to more vehicles. It is likely to receive more consideration. Therefore, traveling ahead generates merit.

FIG. 8 is a conceptual drawing illustrating an outline of a system in a second embodiment. A system 200 illustrated in FIG. 8 includes a leading vehicle 1, a plurality of following vehicles 2, and a server 3. The leading vehicle 1 and the plurality of following vehicles 2 form a platoon 100. Each of the following vehicles 2 travels while communicating with the leading vehicle 1 to maintain a predetermined distance between the vehicles. The server 3 and each of the vehicles are connected with each other through wireless communication through a communication network to communicate with each other.

FIG. 9 is a block diagram illustrating a configuration of the server that is a controller according to the second embodiment. The server 3 includes a storage unit 30, a control unit 31, and a communication unit 32.

The storage unit 30 preliminarily stores profitable information that profits a manager who manages the leading vehicle 1 or a person who requests the travel (the profitable information is, for example, service information, such as a coupon or an advertisement, that promotes sales if the leading vehicle is a commercial vehicle). The storage unit 30 also stores information transmitted or received through the communication unit 32. The storage unit 30 includes ROM and RAM.

The control unit 31 receives vehicle information about each of the following vehicles from the leading vehicle 1 through the communication unit 32. The control unit 31 transmits, to each of the following vehicles 2 through the communication unit 32, the service information in the storage unit 30. The control unit 31 includes a CPU.

FIG. 10 is a flowchart of details of control performed by a controller of the leading vehicle in the second embodiment.

Steps S51 to S54 are similar to Steps S1 to S4 in FIG. 4, and thus will not be described.

In Step S55, a control unit 151 transmits vehicle information about following vehicles 2 and a service information transmission request to the server 3 through a communication unit 152. Then a controller 15 ends the flowchart of control.

FIG. 11 is a flowchart of details of control performed by the server. In Step S61, the control unit 31 determines whether or not vehicle information about following vehicles 2 and a service information transmission request have been received from the leading vehicle 1 through the communication unit 32. If the control unit 31 determines that “vehicle information and a service information transmission request have not been received” (Step S61: No), the server 3 ends the flowchart of control. If the control unit 31 determines that “vehicle information and a service information transmission request have been received” (Step S61: Yes), the control unit 31 transmits service information in the storage unit 30 to the following vehicles 2 that correspond to the received vehicle information (Step S62). Then Step S63 is performed.

In Step S63, the control unit 31 determines whether or not information that indicates that the service information has not been received has been received from the following vehicles 2 through the communication unit 32 within a predetermined period of time. If the control unit 31 determines that “information that indicates that the service information has not been received has been received within the predetermined period of time” (Step S63: Yes), the control unit 31 performs Step S62 again. If the control unit 31 determines that “information that indicates that the service information has not been received has not been received within the predetermined period of time” (Step S63: No), the control unit 31 ends the flowchart of control.

As described above, the server 3 stores the service information, and transmits the service information to each of the following vehicles 2. Therefore, a communication load on the leading vehicle 1 in the second embodiment is smaller than a communication load on the leading vehicle 1 that communicates the service information to the plurality of following vehicles 2 without help of the server 3.

FIG. 12 is a conceptual drawing illustrating an outline of a system in a third embodiment. A system 300 illustrated in FIG. 12 includes a platoon 100A and a settlement server 4. The platoon 100A includes a leading vehicle 1A and one or a plurality of following vehicle(s) 2A. The leading vehicle 1A and the plurality of following vehicles 2A that are close to each other communicate with each other, and perform supply and receipt of electrical energy. Each of the vehicles is connected with the settlement server 4 through a communication network to communicate with the settlement server 4. The vehicles may communicate with each other through the communication network. Note that in FIG. 12, the number of the following vehicles 2A is two, as an example.

The settlement server 4 includes a storage unit 40, a control unit 41, and a communication unit 42. The storage unit 40 includes RAM and ROM. The control unit includes a CPU. The storage unit 40 stores, for example, information in which each of the following vehicles 2A and a managers who manage at least one of the following vehicles 2A are related to each other, information about an account of the manager, and information about a settlement history of the manager. The control unit 41 receives charge information from the leading vehicle 1A through the communication unit 42. Based on the charge information, the control unit 41 checks information about the manager related to the following vehicle 2A that is charged a charge. After the control unit 41 checks the validity, the control unit 41 settles the charge. The control unit 41 transmits settlement information through the communication unit 42 to the following vehicle 2A that has been charged the charge. The settlement information includes the settled charge and settlement completion information. The settlement server 4 may transmit the settlement information to the leading vehicle 1A. In the present embodiment, the settlement server 4 manages an account of a manager of the at least one of the following vehicles 2A that is charged a charge, and the settlement server 4 checks validity of the account. Instead of the settlement server 4, another server may manage the account and may perform the check process.

FIG. 13 is a block diagram illustrating a configuration of the leading vehicle in the third embodiment. The leading vehicle 1A includes a controller 15. The controller 15 includes a control unit 151, a communication unit 152, an electrical-energy supply and receipt device 153, and a charge calculation unit 154. The controller 15 is a controller according to the third embodiment. Hereinafter, a configuration of the leading vehicle 1A illustrated in FIG. 13 that is similar to the configuration of the leading vehicle 1 illustrated in FIG. 2 will not be described.

The control unit 151 includes an electrical-energy control unit 151A. The control unit 151 is connected with a storage unit 150, the communication unit 152, the charge calculation unit 154, and an ECU 14 through electric cables. The control unit 151 transmits, through the communication unit 152, travel information about the leading vehicle 1A, information about an entry position into the platoon 100A, and vehicle information about the following vehicle(s) 2A. The control unit 151 includes a CPU.

The electrical-energy control unit 151A is connected with the electrical-energy supply and receipt device 153 through electric cables. The electrical-energy control unit 151A controls the electrical-energy supply and receipt device 153 based on an electrical-energy charging request that has been detected from the following vehicle 2A through the communication unit 152. An amount of electrical energy with which the following vehicle 2A is charged is transmitted to the charge calculation unit 154.

The electrical-energy supply and receipt device 153 is a device for performing supply and receipt of electrical energy between vehicles. The electrical-energy supply and receipt device 153 is at a rear of the leading vehicle 1A. The rear is relative to a direction in which the leading vehicle 1A travels. The electrical-energy supply and receipt device 153 supplies electrical energy to the following vehicle 2A.

The charge calculation unit 154 calculates a charge for each of the vehicles based on the amount of electrical energy with which the following vehicle 2A is charged. The charge calculation unit 154 transmits a result of the calculation to the settlement server 4 through the communication unit 152.

FIG. 14 is a block diagram illustrating a configuration of the following vehicle in the third embodiment. A configuration of the following vehicle 2A illustrated in FIG. 14 that is similar to the configuration of the following vehicle 2 illustrated in FIG. 3 will not be described.

An input and output unit 25 receives input of an electrical-energy charging request from a person in the vehicle, and outputs and displays electrical-energy supply permission information received through a communication unit 272A.

An electrical-energy control unit 271A supplies electrical energy to a driving device 21 (for example, a battery). The electrical energy has been charged through an electrical-energy supply and receipt device 273. The electrical-energy control unit 271A determines whether or not charging has been completed based on a battery charge level. The electrical-energy control unit 271A transmits electrical-energy charging completion information to the leading vehicle 1A through the communication unit 272A.

The communication unit 272A performs communication between vehicles that are close to each other, and receives settlement information from the settlement server 4 after completion of supply of electrical energy.

The electrical-energy supply and receipt device 273 is a device for performing supply and receipt of electrical energy between vehicles. The electrical-energy supply and receipt device 273 is at a front and a rear of the following vehicle. The front and the rear are relative to a direction in which the following vehicle travels. The electrical-energy supply and receipt device 273 is connected with the electrical-energy control unit 271A through electric cables. The electrical-energy supply and receipt device 273 has a function of receiving electrical energy from the leading vehicle 1A. If a following vehicle 2A that follows the following vehicle 2A makes an electrical-energy charging request, the electrical-energy supply and receipt device 273 has an intermediation function of supplying another following vehicle 2A with electrical energy received from the leading vehicle 1A.

FIG. 15 is a flowchart of details of control performed by the controller of the leading vehicle in the third embodiment. Steps S71 to S74 are similar to Steps S1 to S4 in FIG. 4, and thus will not be described.

In Step S75, the control unit 151 transmits electrical-energy supply permission information to a following vehicle 2A through the communication unit 152. Then Step S76 is performed.

In Step S76, the control unit 151 determines whether or not an electrical-energy charging request has been received from the following vehicle 2A through the communication unit 152. If the control unit 151 determines that “an electrical-energy charging request has not been received” (Step S76: No), the control unit 151 ends the flowchart of control. If the control unit 151 determines that “an electrical-energy charging request has been received” (Step S76: Yes), the electrical-energy control unit 271A allows electrical energy to be supplied to the following vehicle 2A through an electrical-energy supply and receipt device 273 (Step S77).

After the electrical-energy supply, the control unit 151 determines whether or not electrical-energy charging completion information has been received from the following vehicle 2A through the communication unit 152 (Step S78). If the control unit 151 determines that “electrical-energy charging completion information has not been received” (Step S78: No), the control unit 151 performs Step S77 again. If the control unit 151 determines that “electrical-energy charging completion information has been received” (Step S78: Yes), the electrical-energy control unit 271A ends the electrical-energy supply. Then Step S79 is performed.

In Step S79, the control unit 151 transmits, to the settlement server 4 through the communication unit 152, a charge calculated by the charge calculation unit 154. Then the controller 15 ends the flowchart of control.

FIG. 16 is a flowchart of details of control performed by a controller of the following vehicle in the third embodiment. Steps S81 to S86 are similar to Steps S21 to S26 in FIG. 5, and thus will not be described.

In Step S87, a control unit 271 determines whether or not electrical-energy supply permission information has been received from the leading vehicle 1A through the communication unit 272A. If the control unit 271 determines that “electrical-energy supply permission information has not been received” (Step S87: No), a controller 27 ends the flowchart of control. If the control unit 271 determines that “electrical-energy supply permission information has been received” (Step S87: Yes), the control unit 271 performs Step S88.

In Step S88, the control unit 271 determines whether or not a driver intends to perform charging. More specifically, the control unit 271 determines whether or not a driver intends to perform charging, based on whether or not the driver or a passenger inputs an electrical-energy charging request into the input and output unit 25. If the control unit 271 determines that “the driver does not intend to perform charging” (Step S88: No), the control unit 271 performs Step S94. If the control unit 271 determines that “the driver intends to perform charging” (Step S88: Yes), the control unit 271 transmits an electrical-energy charging request to the leading vehicle 1A through the communication unit 272A (Step S89).

After Step S89, the electrical-energy control unit 271A determines whether or not electrical energy has been received through the electrical-energy supply and receipt device 273 (Step S90). If the electrical-energy control unit 271A determines that “electrical energy has not been received” (Step S90: No), the electrical-energy control unit 271A performs Step S89 again. If the electrical-energy control unit 271A determines that “electrical energy has been received” (Step S90: Yes), the electrical-energy control unit 271A determines whether or not the charging has been completed (Step S91).

If in Step S91, the electrical-energy control unit 271A determines that “the charging has not been completed” (Step S91: No), Step S91 is repeated until the charging is completed. If the electrical-energy control unit 271A determines that “the charging has been completed” (Step S91: Yes), the electrical-energy control unit 271A transmits electrical-energy charging completion information to the leading vehicle 1A through the communication unit 272A (Step S92). Then Step S93 is performed.

In Step S93, the control unit 271 receives settlement information from the settlement server 4 through the communication unit 272A. The settlement information is information that includes a charging charge calculated by the charge calculation unit 154 of the leading vehicle 1A, and information about completion of settlement by the settlement server 4. After Step S93, the control unit 271 ends the flowchart of control.

In Step S94, the electrical-energy control unit 271A determines whether or not electrical energy has been received through the electrical-energy supply and receipt device 273. If the electrical-energy control unit 271A determines that “electrical energy has not been received” (Step S94: No), the controller 27 ends the flowchart of control. If the electrical-energy control unit 271A determines that “electrical energy has been received” (Step S94: Yes), the control unit 271 performs Step S95.

In Step S95, the electrical-energy control unit 271A supplies, to another following vehicle 2A that travels and follows the following vehicle 2A through the electrical-energy supply and receipt device 273, electrical energy received from the leading vehicle 1A. Then the controller 27 ends the flowchart of control.

As described above, the leading vehicle 1A supplies electrical energy to the following vehicle(s) 2A, and receives a charge(s) that correspond(s) to an amount(s) of electrical energy. Therefore, the third embodiment allows the leading vehicle 1A that travels ahead in the platoon 100A to generate merit.

The present disclosure should not be limited to the embodiments described above. For example, in the first embodiment, the service information is information related to a product, as an example. The service information may be, for example, information that advertises a tourist attraction. Further, a supplied service may be a paid service supplied by transmitting information or energy. The paid service includes, for example, distribution of paid videos or music, or receipt of tax payment.

In the first embodiment, the leading vehicle 1 and each of the following vehicles 2 directly communicate with each other. However, the leading vehicle 1 and each of the following vehicles may indirectly communicate with each other through vehicles that are close to each other.

In the modification of the first embodiment, as the distance becomes shorter, an amount or quality of the service information is increased. However, an amount or quality of the service information may be increased as a period of time from entry of the following vehicle 2 into the platoon 100 (platoon stay time) becomes longer. Instead of the amount or quality of the service information, a transmission speed may be increased as the distance becomes shorter or the platoon stay time becomes longer.

An amount or quality of the service information may be increased as the distance becomes longer or the platoon stay time becomes shorter. As the distance becomes longer, a distance between the vehicles becomes longer, and another vehicle more easily enters the platoon. Therefore, the service information is transmitted to more vehicles. As the platoon stay time becomes shorter, turnover of vehicles that enter the platoon becomes faster. The service information is transmitted to many vehicles.

In the second embodiment, the leading vehicle 1 and the following vehicles 2 communicate with each other to control platoon travel. However, each of the vehicles and the server 3 may communicate with each other to perform platoon travel.

In the third embodiment, the settlement server 4 performs, for example, a settlement process based on completion of charging. The settlement server 4 may perform a settlement process in response to the following vehicle 2A leaving the platoon 100A. Alternatively, the settlement server 4 may perform a settlement process in response to charging completion information. The charging completion information is from the following vehicle 2A and ends charging.

In the third embodiment, each of the following vehicle(s) 2A may directly communicate with the leading vehicle 1A, or may communicate with the leading vehicle 1A through, for example, a server.

The present disclosure allows a vehicle that travels ahead in a platoon to generate merit by transmitting profitable information or energy to a following vehicle. The profitable information or energy profits a manager who manages the leading vehicle or a person who requests the travel.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A controller comprising:
a processor comprising hardware, the processor being configure to
control a leading vehicle in a platoon formed by a plurality of vehicles to supply profitable information or energy that profits a manager who manages the leading vehicle or a person who requests travel of the leading vehicle to a following vehicle in the platoon, the plurality of vehicles communicating with each other to form the platoon.

2. The controller according to claim 1, wherein the profitable information is information about a service supplied to a person in the following vehicle, and the manager or the person who requests the travel receives consideration for the service.

3. The controller according to claim 1, wherein the profitable energy is energy supplied to the following vehicle such that the manager or the person who requests the travel receives consideration.

4. The controller according to claim 1, wherein the processor is configured to vary at least one of an amount and quality of the supplied information or energy in accordance with a distance between the following vehicle and a vehicle that travels in front of the following vehicle.

5. The controller according to claim 1, wherein the processor is configured to vary at least one of an amount and quality of the supplied information or energy in accordance with a length of time from entry of the following vehicle to which the information or the energy is supplied into the platoon.

6. The controller according to claim 1, wherein the controller is provided in the leading vehicle.

7. The controller according to claim 1, wherein the controller is configured to communicate with the plurality of vehicles.

8. The controller according to claim 1, wherein
the energy is electrical energy, and
the processor is configured to control vehicles in the platoon to perform supply and receipt of the electrical energy between the vehicles without contact.

9. The controller according to claim 8, wherein the processor is configured to calculate a charge based on an amount of the electrical energy supplied and received.
